(19) United States
(12) Patent Application Publication
(10) Pub. No.: US 2008/0205036 A1
(43) Pub. Date: Aug. 28, 2008

(54) SINGLE AXIS HEADLAMP

(75) Inventors: Kevin J. Tarter, Wichita, KS (US); Derrick D. Lenz, Wichita, KS (US)

Correspondence Address: Kelly S.K. Elsea;Intellectual Property Counsel for, The Coleman Company, Inc., 3600 N. Hydraulic, Wichita, KS, 67219, US

(73) Assignee: THE COLEMAN COMPANY, INC., Wichita, KS (US)

(21) Appl. No.: 12/031,591

(22) Filed: Feb. 14, 2008

Related U.S. Application Data
(60) Provisional application No. 60/892,002, filed on Feb. 28, 2007.

(51) Int. Cl. F21V 21/084

(52) U.S. Cl. 362/105

(57) ABSTRACT

A headlamp (10) that is aimed by rotation. The headlamp (10) includes a head mount (20) and a body (22) having a light source (60, 62). The head mount (20) is held to a user's head by a strap (12). The body (22) rotates relative to the head mount (20) about an axis so that the body (22) remains the same distance from the user's forehead as the light emitted from the light source is pivoted up and down.

### REFERENCE TO RELATED APPLICATIONS

This application claims priority to U.S. provisional patent application Ser. No. 60/892,002, filed Feb. 28, 2007, and incorporated herein by reference.

### TECHNICAL FIELD OF THE INVENTION

The present invention relates to lamps and more particularly to headlamps.

### BACKGROUND OF THE INVENTION

Headlamps are lamps designed to be worn on a user's head. Usually headlamps are secured to a user's head by a strap extending around the head, although they can be attached to hats, helmets, or other types of headgear. Headlamps are useful in that they allow users to illumine an area without using their hands, so that their hands are free to be used on other tasks. Generally, headlamps emit beams of light, where the term “beam” includes a collection of substantially parallel rays of light, a cone of light, or, generally, a pattern of light directed to a general direction.

To aim a headlamp, a user can turn his or her head side to side or up and down. Depending on what is being illumined, a user may have to hold his or her head in an uncomfortable position for a significant amount of time in order to keep a beam aimed correctly. For example, if someone wearing a headlamp needs to illumine a low area, then he or she would need to move his or her head downwards, which may be uncomfortable, especially for an extended period of time. Therefore, headlamps that can be aimed independent of a user turning his or her head are desirable.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

In accordance with an embodiment, a headlamp is provided. The headlamp includes a strap and a lamp, the lamp having a head mount and a body. The body has at least one light source and rotates relative to the head mount about an axis.

Other features of the invention will become apparent from the following detailed description when taken in conjunction with the drawings, in which:

### BRIEF DESCRIPTION OF THE DRAWINGS

FIG. 1 is a side perspective view of a headlamp in accordance with an embodiment;

FIG. 2 is a front perspective view of the headlamp of FIG. 1;

FIG. 3 is a bottom, side perspective view of the headlamp of FIG. 1 with a battery door in an opened configuration;

FIG. 4 is a side view of the headlamp of FIG. 1 as worn by a user;

FIG. 5 is a top view of the headlamp of FIG. 1;

FIG. 6 is a side view of the headlamp of FIG. 1, with a beam from the headlamp directed in an upward direction;

FIG. 7 is a side view of the headlamp of FIG. 1, with a beam from the headlamp directed in an downward direction; and

FIG. 8 is a cross-sectional view taken along the section lines 8-8 of FIG. 4.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

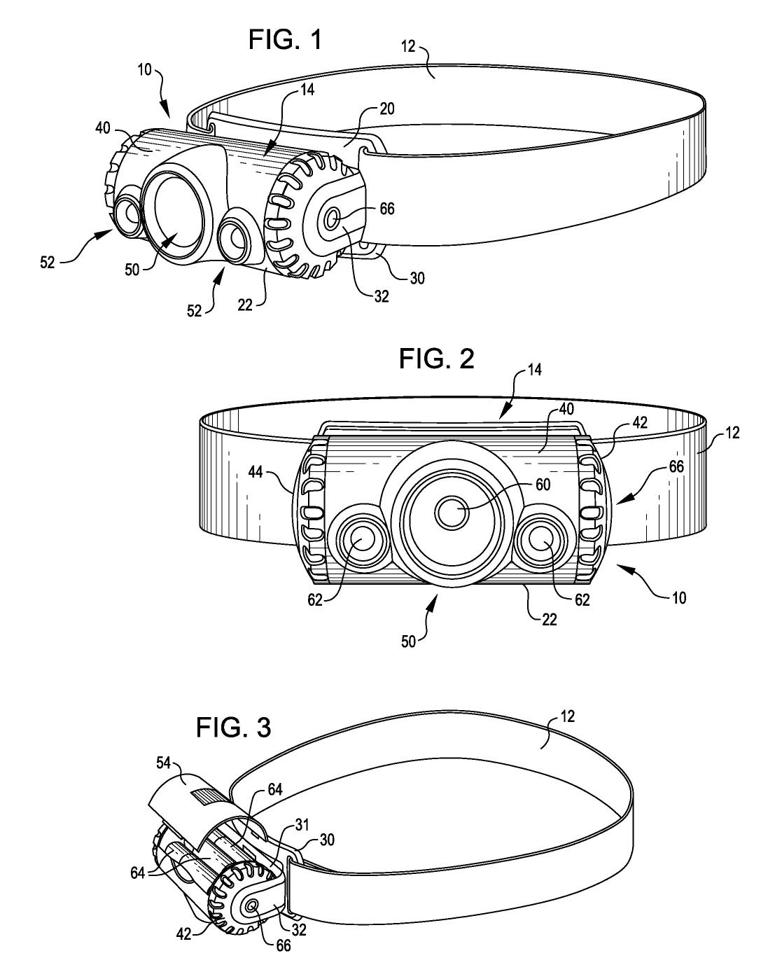

Referring now to the drawings, in which like reference numerals represent like parts throughout the several views, FIG. 1 shows a headlamp 10 in accordance with an embodiment. The headlamp 10 includes a strap 12 and a lamp 14. The strap may be, for example, an elongated strip of elastic material configured to wrap around a user's head and attached to the lamp 14 in at least one place. Other headband materials or structures may be used.

The lamp 14 includes a head mount 20 and a body 22 attached to the head mount 20. The head mount 20 is the portion of the lamp 14 configured to support the lamp 14 and connect the lamp 14 to the strap 12 or other structure that attaches to a user's head.

In the embodiment shown in the drawing, the head mount 20 holds the lamp 14 against a person's head and includes a head plate 30, a bracket 31, and a cushion 34. The head plate 30 is a thin, rectangular piece of material, such as plastic, curved in a crescent shape to match the curvature of a typical person's forehead. The bracket 31 is a U-shaped member configured to attach to the convex side of the head plate 30 and includes a pair of arms 32. Each arm 32 is a piece of material extending from the bracket 31 away from the convex side of the surface of the head plate 30. In an alternate embodiment, the arms 32 may extend directly from the head plate 30. In either case, the distance between the arms is equal approximately to the width of the body 22. In the embodiment shown in the drawings, the arms extend perpendicularly from the head plate 30, but the arms may extend in other directions relative to the head plate.

The cushion 34 may be, for example, a thin rectangular piece of soft or spongy and perhaps absorbent material such as foam rubber or terrycloth that is attached to the concave, back side of the head plate 30. The body 22, in an embodiment, is the portion of the lamp 14 that emits light and includes a casing 40, a first end cap 42 and a second end cap 44. In general, the body 22 can be any structure suitable for maintaining a light source for use with the head lamp 10. The casing 40 is substantially in the form of a cylinder. The end caps 42, 44 are in the shape of disks configured to attach to and close the ends of the casing 40. In an embodiment, the end caps 42, 44 are rigidly connected to the body 22. As shown in FIG. 3, the end cap 42 is rotatably connected to one of the arms 32. Likewise, the end cap 44 is rotatably connected to the other arm 32.

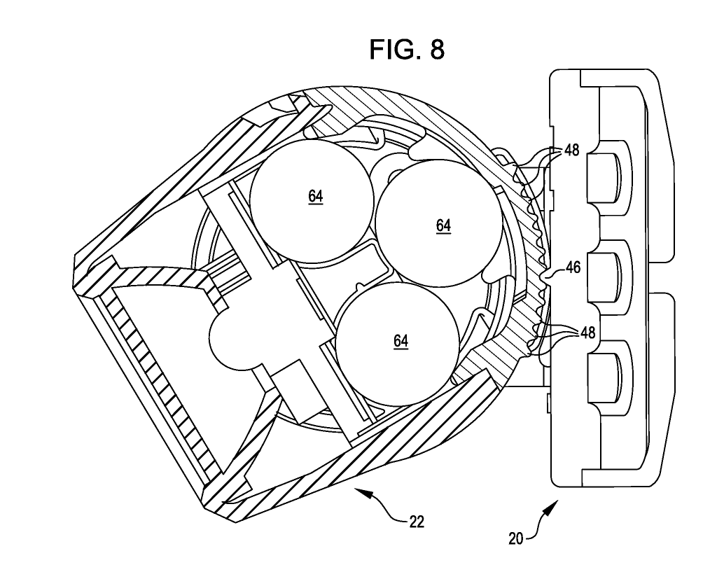

As is further described below, rotatably connecting the end caps 42, 44 to the arms 32 allows the body 22 to rotate relative to the head mount 20 about a central axis defined by the rotatable connection of the end caps 42, 44 to the arms 32. As shown in FIG. 8, the head mount 20 may include a raised rib 46, which is a protrusion having a triangular cross section extending horizontally along a portion of the convex side of the head mount 20. The casing 40 may have a plurality of serrations 48, which comprise a series of parallel notches similar in size and shape and parallel to the raised rib 46. The casing 40 and the head mount 20 are configured so that the raised rib 46 and serrations 48 work together to prevent the body 22 from freely rotating relative to the head mount 20. In particular, the raised rib 46 is engaged on opposite sides by a serration 48 and frictional forces between the raised rib 46 and the serration 48 prevent the body 22 from rotating relative to the head mount 20.

In an embodiment, there are frictional forces at the rotatable connections between the end caps 42, 44 and the arms 32 that prevent the body 22 from freely rotating relative to the head mount 20. These frictional forces can result from, for example, a tight connection between the arms 32 and the end caps 42, 44, a rubber grommet that restricts rotation of the body 22, or another suitable structure.

The casing 40 includes an aperture 50 in its front and may include additional apertures 52 located near the aperture 50. As shown in FIG. 3, in accordance with an embodiment, the casing 40 may include a battery door 54 that is pivotally attached to the casing 40 and the opening of which allows access to the interior of the body 22 inside the casing 40. Other configurations for accessing the interior of the body 22 may also be used. For example, one or more of the end caps 42, 44 may be removable to provide access.

The lamp 14 includes an electrical circuit (not shown) that includes a light source in each aperture 50, 52, such as light emitting diodes (LEDs) 60, 62 located in the apertures 50, 52, respectively. Other light sources may be used, including fluorescent or incandescent lamps. The apertures 50, 52 may additionally include reflectors for appropriately directing light for the LEDs 60, 62 or other light source.

The lamp 14 also includes a power source, such as the batteries 64, and a switch 66. The electrical circuit may be equivalent to common circuits well known in the art of headlamps and flashlights, or other circuits may be used. As shown in the drawings, the switch 66 is a push button switch located in the center of the first end cap 42, but the switch 66 may alternatively be a rotating switch attached to or integrated into the first end cap 42 such that the switch 66 can be put in an opened or closed configuration by rotating the first end cap 42. The switch 66 opens and closes the circuit such that, when the circuit is in the closed position, the batteries 64 provide power to the LEDs 60, 62, thereby causing the LEDs 60, 62 to emit light through the apertures 50, 52, respectively.

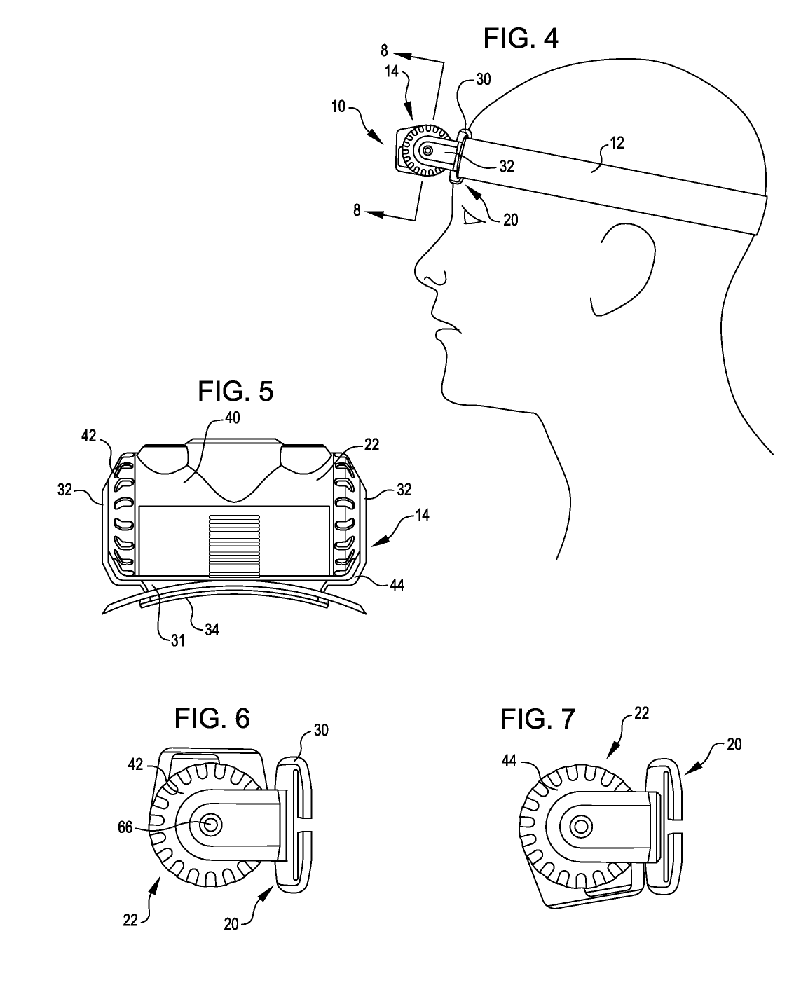

A user may use the headlamp 10 by securing the strap 12 around his or her head, as shown in FIG. 4, such that the head plate 30 and the cushion 34 engage the user's forehead. The user may activate the switch to close the circuit and cause light to be emitted by the LEDs 60, 62. If the user wishes to aim the direction of emitted light in a different direction, he or she may apply enough rotational force to overcome the frictional forces preventing the body 22 from freely rotating in order to rotate the body 22 up or down relative to the head mount 20 until the light shines in the desired direction. For example, if the user wishes to aim the light lower, he or she may grip the body 22 and rotate it down about the axis formed by the rotatable connections of the end caps 42, 44 to the arms 32. During rotation, the raised rib 46 may pass over one the portions of the casing 40 between consecutive serrations 48 thereby producing a click sound as the raised rib 46 passes over each portion between consecutive serrations 48. Any of the above-mentioned frictional forces keep the body 22 secured at the new angle chosen by the user. Similarly, if the user wishes to aim the light higher, he or she may grip the body 22 and rotate it up about the axis defined by the connections of the end caps 42, 44 to the arms 32.

As shown in FIG. 4, the axis defined by the connections of the end caps 42, 44 to the arms 32 passes near the center of a cross section of the body 22, the cross section formed, when the headlamp 10 is worn as in FIG. 4, by an intersection of the body 22 and a vertical plane passing through the user's nose and the midpoint between the user's ears. The axis is also approximately normal to this plane. The axis is, therefore, located a distance away from a user's forehead. Because the headlamp 10 is configured with this axis, and because the headlamp 10 is configured so that the body 22 rotates relative to the head mount 20, the body 22 remains approximately the same distance from the head mount 20 regardless of the direction the light is aimed. In addition, the center of mass of the lamp 14 remains approximately in the same position regardless of the direction the light is aimed. This effect can also be achieved using alternate embodiments. For instance, the end caps 42, 44 may be rigidly connected to the arms 32, but rotatably connected to the casing 40, so that a user aims the light by rotating the casing 40 relative to the end caps 42, 44.

In addition, as can be seen in FIG. 6, having body 22 rotate on an axis that is spaced from the forehead allows the headlamp 10 to be aimed so that light shines directly upward. Likewise, as can be seen in FIG. 7, the headlamp 10 may be aimed so that light shines directly downward. In general, the light from the body 22 of the headlamp 10 can be aimed at any angle between the directly upward angle and the directly downward angle.

As shown in FIG. 2, the headlamp 10 has an LED 60 and two LEDs 62, for a total of three LEDs. However, any number of LEDs may be used. For example, a headlamp 10 may have only one LED, or it may have two, or more than three. In addition, if a headlamp 10 has multiple LEDs, the circuitry of the headlamp 10 may be such to allow a user to select which LEDs emit light. For instance, the headlamp 10 shown in the drawings may have a rotating switch that allows a user to choose among three modes, the first where no light is emitted from any LED, the second where light is emitted from the LED 60, and the third where light is emitted from all the LEDs 60, 62. Such a configuration has an advantage in that it allows a user to choose whether he or she prefers more brightness or longer battery life.

Other configurations are also possible. For instance, other light sources, such as incandescent lamps, can also be used in the headlamp 10. In addition, the headlamp may include a reflector or lens to focus light in a beam. Such a reflector or lens may be adjustable so that a user may choose to illumine a narrow area or a broad area.

As shown in FIG. 6 and FIG. 7, the headlamp 10 can be rotated to any angle within an arc of approximately 180 degrees due to the body 22 engaging the head mount 20 when the light is being directed directly up or directly down. However, the headlamp 10 may be configured to have a smaller range of rotation, or it may be configured to have a larger range of rotation. For example, the arms 32 may be configured to extend slightly further than shown in the drawings so that the body 22 may rotate freely and not engage the head mount 20 so that the body 22 may rotate 360 degrees without interference. In addition, the headlamp 10 may be configured so that the body 22 may be rotated to any of a discrete set of angles.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A headlamp, comprising:
a head mount having a first surface configured to be secured against a forehead of a person;
one or more arms extending from the head mount; and
a body having a light source, the body rotatably connected to said one or more arms so that the body is rotatable about a central axis extending horizontally and parallel to the forehead when the headlamp is worn by the person, the central axis extending through an interior central region of the body.

2. The headlamp of claim 1, wherein the light source emits a beam of light projecting along a ray extending perpendicularly from the central axis.

3. The headlamp of claim 1, wherein the body is substantially cylindrical, capped by a first disk on a first end and a second disk on a second end, and the central axis extends through the first and second disks.

4. The headlamp of claim 3, wherein the first disk and second disk are concentric with the central axis of the body.

5. The headlamp of claim 1, further comprising a mechanism for selectively preventing rotation of the body relative to said one or more arms.

6. The headlamp of claim 1, wherein the light source projects a beam and the body is rotatable through an angle defined by a first position and second position of the body, the beam projecting above a horizontal plane when the body is in the first position, projecting below the horizontal plane when the body is in the second position, and projecting away from the person when the body is in a third position between the first position and second position, the horizontal plane being approximately normal to the forehead when the headlamp is worn by the person.

7. The headlamp of claim 6, wherein the distance of the body to the head mount is independent of an angular position of the body for angular positions between the first position and the second position.

8. The headlamp of claim 6, wherein the angle is approximately 180 degrees.

9. A headlamp, comprising:
a head mount having a first surface configured to be secured against a forehead of a person; and
a body having a light source for projecting a light beam, the body rotatably connected to the head mount so that the body is rotatable about an axis extending horizontally through the body so that the light beam projects along a ray extending perpendicularly from the axis.

10. The headlamp of claim 9, the head mount further comprising one or more arms extending from the body.

11. The headlamp of claim 9, wherein the axis extends through a central interior portion of the body.

12. The headlamp of claim 9, wherein the body is rotatable through an angle defined by a first position and second position of the body, the beam projecting above a horizontal plane when the body is in the first position, projecting below the horizontal plane when the body is in the second position, and projecting away from the person when the body is in a third position between the first position and second position, the horizontal plane being approximately normal to the forehead when the headlamp is worn by the person.

13. The headlamp of claim 12, wherein the angle is approximately 180 degrees.

14. The headlamp of claim 9, further comprising a mechanism for selectively preventing rotation of the body relative to the head mount.

15. The headlamp of claim 9, wherein the body is substantially cylindrical, capped by a first disk on a first end and a second disk on a second end, and the axis extends through the first and second disks.

16. The headlamp of claim 15, wherein the first disk and second disk are concentric with the axis.

17. A headlamp, comprising:
a head mount having a first surface configured to be secured against a forehead of a person; and
a body having a light source for projecting a light beam, the body rotatably connected to the head mount and rotatable through an angle defined by a first position and second position of the body, the beam projecting above a horizontal plane when the body is in the first position, projecting below the horizontal plane when the body is in the second position, and projecting away from the person when the body is in a third position between the first position and second position, the horizontal plane being approximately normal to the forehead when the headlamp is worn by the person.

18. The headlamp of claim 17, wherein the distance of the body to the head mount is independent of an angular position of the body for angular positions between the first position and the second position.

19. The headlamp of claim 17, further comprising one or more arms extending from the head mount and rotatably connected to the body.

20. The headlamp of claim 17, wherein the body is rotatable about an axis extending horizontally through the body so that the light beam projects along a ray extending perpendicularly from the axis.

21. The headlamp of claim 17, wherein the body is substantially cylindrical, capped by a first disk on a first end and a second disk on a second end, and a central axis extends through the first and second disks.

22. The headlamp of claim 21, wherein the first disk and second disk are concentric with the central axis.

23. The headlamp of claim 17, further comprising a mechanism for selectively preventing rotation of the body relative to the head mount.

24. The headlamp of claim 17, wherein the distance of the body to the head mount is independent of an angular position of the body for angular positions between the first position and the second position.

25. The headlamp of claim 17, wherein the angle is approximately 180 degrees.
